(19) United States
(12) Patent Application Publication
(10) Pub. No.: US 2008/0154689 A1
(43) Pub. Date: Jun. 26, 2008

(54) Automated Claim Access System and Method For Claims Adjudication

(75) Inventors: Peter Thum, Gorham, ME (US); John R. Ferguson, Concord, MA (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: GENERAL ELECTRIC COMPANY, Schenectady, NY (US)

(21) Appl. No.: 11/615,523

(22) Filed: Dec. 22, 2006

(51) Int. Cl. G06Q 10/00; G06Q 30/00; G06F 9/46

(52) U.S. Cl. 705/9; 705/34; 719/318

(57) ABSTRACT

A system and method for automatedly identifying an event on a financial system that may potentially impact one or more financial claims and automatedly accessing the one or more potentially impacted financial claims for processing.

### FIELD OF THE INVENTION

The present invention generally relates to the field of financial claim management. In particular, the present invention is directed to an automated claim access system and method for claims adjudication.

### BACKGROUND

A financial claim may be presented from one party to another party for payment related to one or more services rendered including the delivery and/or sale of goods. The receiving party typically processes the claim to determine if it will approve the claim for payment or reject it based on some criteria. Frequently a financial claim may require reprocessing to take into account new information acquired by a claims management system when the new information may impact the status of the claim. In a healthcare environment, financial claims are typically presented by a healthcare provider to a party responsible for the payment of the claim. The responsible party is often a third-party payer (e.g., an insurance company, Medicare, Medicaid, etc.). Third-party payers utilize rules to determine if the claim should be paid in full, paid in part, or rejected based on the services rendered, the provider rendering the services, the format of the claim, and/or other criteria. The process of adjudicating the status of a claim may be complicated and time consuming, especially where human intervention is required to progress a claim through the process. In healthcare claims processing, the time requirements are augmented by the large volume of claims handled by a typical third-party payer. Reduction of time and man hours required to process a claim is desireable.

### SUMMARY OF THE DISCLOSURE

In one embodiment, a computerized method of processing a financial claim is provided. The method includes automatedly identifying an event on a financial system, the event potentially impacting a status of one or more financial claims residing in a first database of the financial system; automatedly accessing the one or more financial claims; processing the one or more financial claims to generate a processed financial claim for each of the one or more financial claims, the processing based at least in part on information obtained from the event.

In another embodiment, a system for processing a financial claim is provided. The system includes a database including one or more financial claims;an event monitor for automatically identifying an event on a financial system, the event impacting a status of the one or more financial claims; a financial claim access module in communication with the database and the event monitor, the financial claim access module for automatedly accessing the one or more financial claims impacted by the event; and a financial claim processing engine, in communication with the database and the financial claim access module, for processing the one or more claims impacted by the event to produce an adjudicated claim.

In yet another embodiment, a system for processing a financial claim is provided. The system includes a means for storing one or more financial claims; a means for automatically identifying an event on a financial system, the event impacting a status of the one or more financial claims; a means for automatedly accessing the one or more financial claims impacted by the event; and a means for processing the one or more claims impacted by the event to produce an adjudicated claim.

In still another embodiment, a computer readable medium containing computer executable instructions implementing a method of processing a financial claim is provided. The instructions include a set of instructions for automatedly identifying an event on a healthcare financial system, the event impacting a status of one or more financial claims residing in a first database of the financial system; a set of instruction for automatedly accessing the one or more financial claims; and a set of instructions for processing the one or more financial claims to generate a processed financial claim for each of the one or more financial claims.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a prior art method of processing a claim;

FIG. 2 illustrates one embodiment of a system for automatedly processing one or more claims;

FIG. 3 illustrates another embodiment of a system for automatedly processing one or more claims;

FIG. 4 illustrates one embodiment of a tasking subsystem;

FIG. 5 illustrates one embodiment of a task object;

FIG. 6 illustrates one embodiment of a system for automatedly processing a previously adjudicated claim;

FIG. 7 illustrates one embodiment of a method for automatedly processing one or more claims; and

FIG. 8 illustrates an exemplary computing environment.

### DETAILED DESCRIPTION

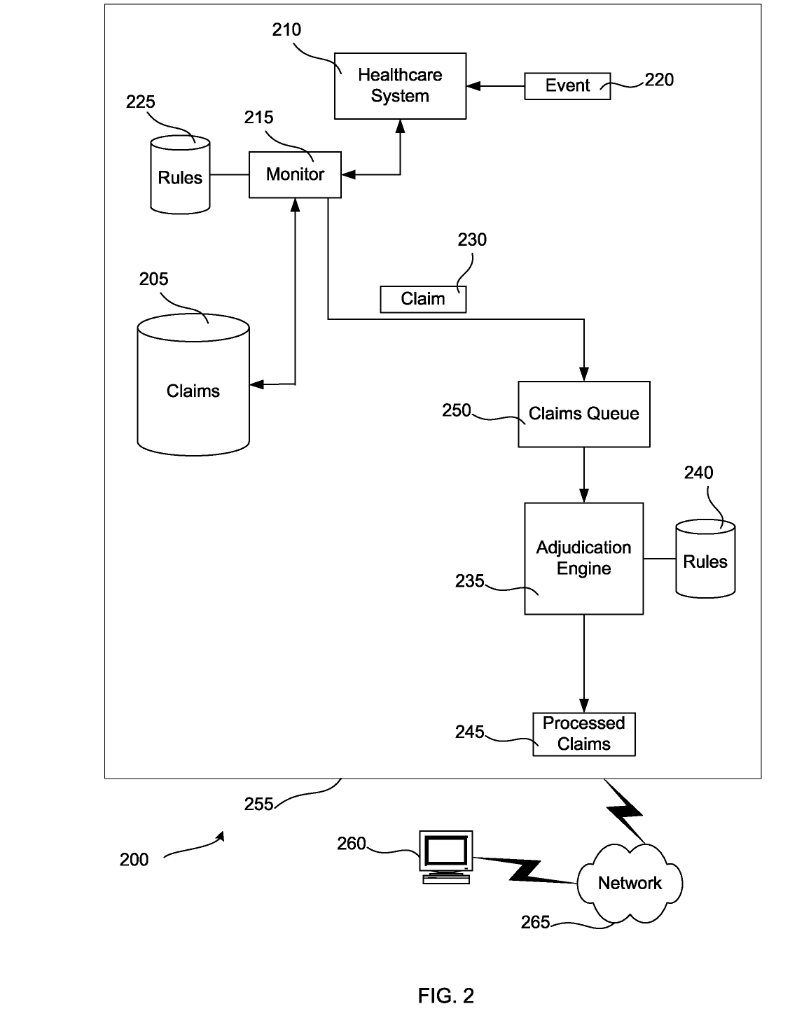

A system and method is presented for automatedly processing a financial claim (e.g., a claim for payment of one or more services rendered). The system and method, as discussed further below with respect to FIGS. 2 to 8, involve the automated accessing of one or more financial claims for processing based on information related an event occurring in the system.

An event may occur related to a financial system that may potentially have an impact on a status of a claim. In one example, an event may impact a claim that has yet to be processed. In another example, an event may impact a claim that has already been processed. A non-processed claim may include a status indicator (e.g., a data flag associated with a claim object in a database and/or table) that has information related to the non-processed status of the claim. A processed claim may have any of a variety of status indicators associated with the claim. An example status for a processed claim may include, but is not limited to, an approved status, a rejected status, and a pended status. In one example, a claim having either a rejected status or an approved status may be considered an adjudicated claim. An adjudicated claim may be considered closed in that a rejected status typically indicates that the claim will not be paid and an approved status typically indicates that the claim will be paid. In another example, a claim may have a pended status where the claim could not be processed for one or more reasons, as will be discussed further below.

Example events that may impact a status of a claim include, but are not limited to, a change being made to information related to a service provider associated with the claim (e.g., a change in insurance plan participation status of the provider, an input of originally missing information about a service provider, etc.), a change being made to information related to a recipient of services associate with the claim (e.g., a change in insurance plan coverage for a patient receiving healthcare services, an input of a pre-existing condition that may impact an insurance coverage, etc.), a change being made to information associated with the claim itself (e.g., a change in a description indicator of a service rendered associated with the claim, a change in a name of a provider associated with the claim, etc.), a change being made to rules for determining an acceptable claim (e.g., a change in insurance plan details, such as services covered, pre-existing condition requirements, providers participating in an insurance plan, etc.), a change being made to a claim object or related information in response to a communication from a provider and/or a services recipient (e.g., a person covered by an insurance plan) after a claim has been rejected, an entire claim being represented to the financial system by a provider of services (e.g., a claim having updated information about a recipient of services, services, etc.), and any combinations thereof.

Regardless of the type of event that may potentially impact a claim, the claim may need to be accessed in order to update the claim and/or reprocess the claim.

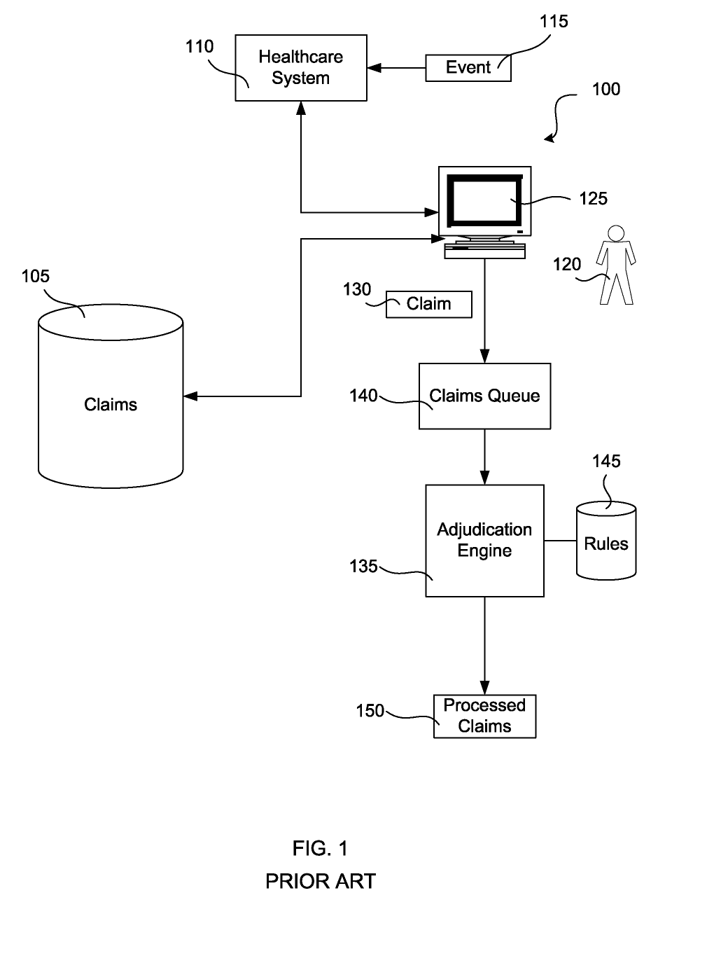

FIG. 1 illustrates a prior art system 100 for processing a financial claim. Claims are stored in a claims database 105 that is associated with a healthcare financial system 110 (e.g., an insurance claims processing system). An event 115 occurs that is related to financial system 110. A user 120 (e.g., a claims processing worker) may then utilize a workstation 125 to access financial system 110 and view an indication of event 115. User 120 may then determine if event 115 may impact a claim stored in claims database 105 by accessing claims database 105 via workstation 125. Upon determining an impacted claim 130, user 120 may then manually submit claim 130 to a claims adjudication engine 135 for processing. In one example, user 120 may submit claim 130 directly to adjudication engine 135 for processing. In another example, user 120 may schedule claim 130 in a queue 140 for later processing via adjudication engine 135. At a predetermined time (e.g., during an overnight lull in processing demands on system 100), queue 140 may submit a one or more claims (including claim 130) to adjudication engine 135 for processing. Adjudication engine 135 is in communication with a rules database 145. Rules database 145 may include information representing rules for approving, rejecting, or pending claim 130. Adjudication engine 135 compares information related to claim 130 to rules in rules database 145 to determine an appropriate status to assign to each claim (e.g., claim 130) and produces one or more processed claims 150 including claim 130. In one example, adjudication engine 135 associates with claim 130 a status indicator (e.g., an approved, rejected, or pended status indicator). As discussed above, the manual human intervention required by user 120 may add undesireable time to the processing of claim 130.

FIG. 2 illustrates one embodiment of a system 200 for automatedly processing one or more claims. System 200 includes a claims database 205 that is associated with a healthcare financial subsystem 210. This and other embodiments discussed herein focus on healthcare financial claims processing. However, as will be clear to those of ordinary skill from the disclosure herein, the methodologies and structures discussed herein may be applied to other financial claims processing.

Claims database 205 includes one or more claims that have been submitted for processing. A claim may exist as any data structure within claims database 205 and more generally within system 200. In one example, a claim may exist as a database object. A database object may exist, for example, in a data table with other database objects (e.g, multiple claim objects and/or other system objects organized in a table). Claims database 205, as well as other databases of system 200, may reside in one or more locations within system 200. In one example, a database (e.g., claims database 205) may exist as a stand alone database structure. In another example, a database (e.g., claims database 205) may share database structure with another database of system 200.

Financial subsystem 210 may include one or more of various aspects of system 200 for processing a claim. Financial subsystem 210 may also include aspects for generally managing information related to the processing of claims. Example aspects that may be managed by financial subsystem 210 include, but are not limited to, receipt of information representing and/or related to a financial claim for payment for one or more services rendered, management of communication with a recipient of one or more services (e.g., a healthcare patient that subscribes to an insurance plan of a third-party payer operating system 200), management of communications with a provider of one or more services, management of one or more rules for operating system 200 (e.g., rules for monitoring system 200 for various events that may impact a claim, rules for adjudicating a claim, etc.), and any combinations thereof.

System 200 also includes a monitor 215 that is communicatively connected with claims database 205 and financial subsystem 210 for monitoring financial subsystem 210 for an event 220 associated therewith that may potentially impact a status of a claim in claims database 205. Monitor 215 may utilize a rules database 225 including one or more rules for automatedly identifying one or more events, such as event 220, that may potentially impact a claim. In one example, rules database 225 may include a rule indicating that when a change is made to a healthcare provider's participation in a particular insurance plan, any claim for one or more services provided by the healthcare provider may be impacted by this change. Prior to the change in status, claims may have been submitted for processing that related to one or more services provided by the particular healthcare provider prior to that healthcare provider being recognized by system 200 as a participating provider. Such claims may have been rejected prematurely and may require reprocessing to properly determine their status.

When an event (e.g., event 220) is identified, monitor 215 may automatedly access an impacted claim 230 from claims database 205. System 200 includes an adjudication engine 235 and an adjudication rules database 240. Adjudication rules database 240 includes one or more rules detailing how a claim should be processed. In the healthcare environment, system 200 may be operated by a third-party payer, such as an insurance company, and adjudication rules database 240 may include rules detailing one or more insurance plans implemented by the third-party insurance provider. An insurance plan may include, but may not be limited to, a list of services that are covered by the plan, a list of pre-existing conditions that may preempt coverage, a list of providers that participate in the plan, a list of individuals that are covered by the insurance plan, rules of implementation of the plan, and any combinations thereof. These and other rules for processing claims are known and may vary from payer to payer. In some cases, rules for adjudicating a claim may include highly complex algorithms for determining whether to approve, reject, or pend a claim. Typically, a pended claim is one for which one or more rules in an adjudication database may not have been able to determine whether to approve or to reject the claim. Adjudication engine 235 utilizes rules database 240 in processing claims. Various adjudication engines are also known. Monitor 215 includes instructions for automatedly accessing one or more claims in claims database 205 that may be impacted by an identified event and determining whether to submit such a claim for processing. Monitor 215 may access identified claim 230 and submit claim 230 to adjudication engine 235 for processing. Adjudication engine 235 may generate one or more processed claims 245. In one example, claim 230, which may be a data object residing in claims database 205, has a status that is modified by adjudication engine 235. For example, a status identifier of claim 230 may be set by adjudication engine 235 to a status of approved, rejected, or pended, depending on the outcome of comparison of claim 230 with one or more adjudication rules of rules database 240. In another example, original claim object 230 remains the same and adjudication engine 235 produces a processed claim object (e.g., processed claim object 250) that includes the information of original claim object 230 with modification to indicate its status (e.g., an approved claim 250 may include financial debit information representing a payment to be made for the one or more services corresponding to original claim object 230. In such an example, original claim object 230 may include, after processing, an indication that it has been previously processed (e.g., a data flag). One or more processed claims 245 may reside in claims database 205. In one example, a data object representing claim 230 resides in claims database 205 throughout processing and is automatedly accessed by various components of system 200 as needed for processing and/or updating of status due to adjudication.

System 200 may optionally include a claims queue 250. In some exemplary situations system 200 may include enough processing resources to submit claims, such as claim 230, to adjudication engine 235 as the claims are identified for processing. In another exemplary situation, system 200 may require that claims be queued in groups prior to submission to adjudication engine 235 for processing. In one example, processing resources of system 200 (e.g., the capabilities of one or more machines on which system 200 resides) may be heavily utilized by other aspects of system 200 (e.g., by financial subsystem 210) at certain times of the day. In such an example, it may be desirable to adjudicate claims during times of the day with lower utilization of processing resources. In another example, it may simply be desirable to adjudicate claims in groups. Claims queue 250 queues claims that have been automatedly identified and accessed by monitor 215 until a predetermined time at which time they are submitted to adjudication engine 235. In one example, claims queue 250 may include a list including a reference to claims residing in claims database 205 that have been identified and/or accessed for processing.

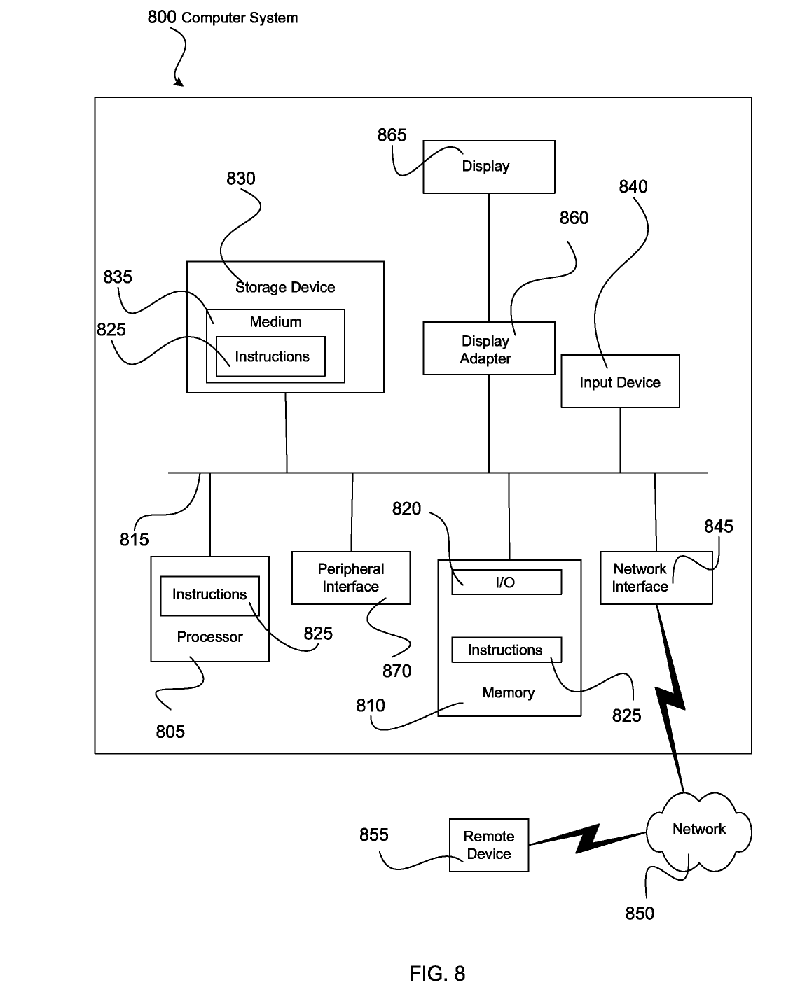

Referring again to FIG. 2, components of system 200 (e.g., claims database 205, healthcare financial system 210, monitor 215, adjudication engine 235, adjudication database 240, claims queue 250, etc.) may reside on the same or different machine, such as a general purpose computing device (e.g., a workstation, a server). An exemplary general purpose computing device is discussed further below with respect to FIG. 8. System 200 is shown as residing on a single machine 255. However, it is contemplated that components of system 200 may reside on multiple machines that operate in a networked environment. System 200 may also be accessed by a user. In one example, a user may access system 200 via a workstation 260 in communication with system 200 via a network segment 265. In another example (not shown), a user may access system 200 via a terminal directly connected with one or more components of system 200.

A user may access system 200 for a variety of reasons. In one example, a user may access system 200 to monitor any aspect of the operation of system 200. In another example, a user may access system 200 to manually intervene in the processing of a claim, such as claim 230. In yet another example, a user may access system 200 for administrative purposes (e.g., updating one or more of rules databases 225, 240). In still another example, system 200 may be accessed (e.g., by a user or automatically) for updating information to financial system 210 (e.g., updating information that may be associated with a claim in claim database 205). In still yet another example, system 200 may be accessed (e.g., by a user or automatically) to print reports detailing one or more aspects of system 200 and/or the processing of one or more claims (e.g., a report detailing approval/rejection/pended status performance of adjudication engine 235).

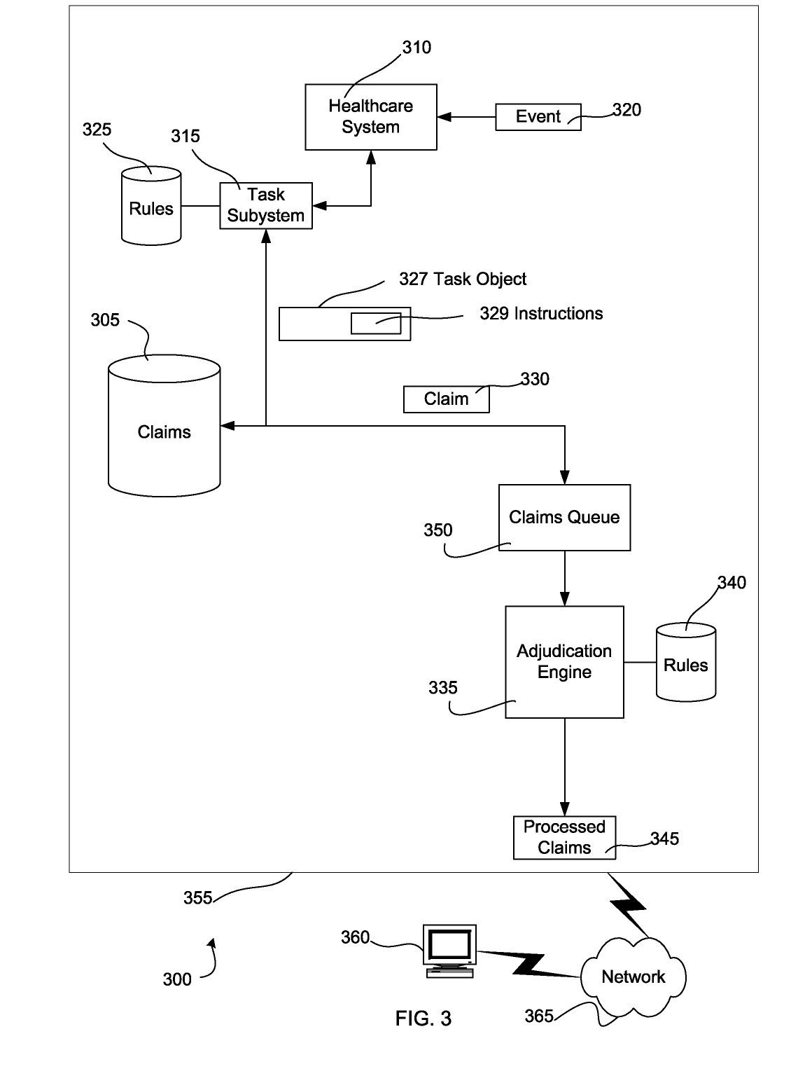

FIG. 3 illustrates another embodiment of a system 300 for automatedly processing one or more claims. System 300 includes components similar to those of system 200 of FIG. 2. Such components are configured and operate in substantially the same manner as described above with respect to system 200. Differences in system 300 are described in detail below.

System 300 includes a claims database 305 having one or more claims and a healthcare financial subsystem 310. System 300 also includes a tasking subsystem 315. Tasking subsystem 315 includes the structure and functionality of a task management system (e.g., a workflow management system). Typically a task management system generates task objects that are manually worked by users (e.g., by presenting the task objects to a user via a worklist for working the tasks). Various task management systems are known. An example task management system with exemplary task objects is set forth in U.S. patent application Ser. No. 10/632,328, filed on Aug. 1, 2003, entitled “Enterprise Task Manager,” which is incorporated herein by reference in its entirety. Task subsystem 315 automatedly monitors financial subsystem 310 for one or more events, such as event 320, that may potentially impact one or more claims in claims database 305. Tasking subsystem 315 may utilize a rules database 325 including one or more rules for automatedly identifying one or more events, such as event 320, that may potentially impact a claim. Upon identifying event 320, tasking subsystem 315 generates a task object 327 that includes one or more executable instructions 329 for automatedly accessing one or more claims in claims database 305 that may be impacted by event 320. Task object 327 executes one or more instruction 329 in accessing the one or more claims, such as claim 330, which is automatedly submitted to an adjudication engine 335. Adjudication engine 335 utilizes one or more adjudication rules in adjudication rules database 340 in processing claim 330 to one or more processed claims 345. System 300 may also include a claims queue 350 for queuing one or more claims (e.g., claim 330) prior to processing by adjudication engine 335.

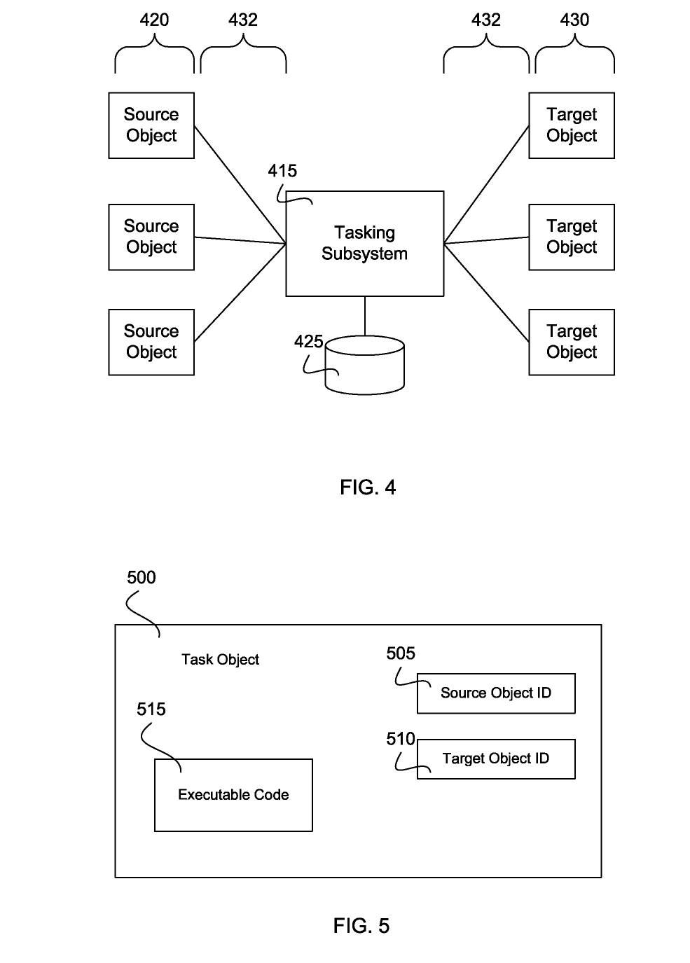

In one exemplary aspect, a tasking subsystem, such as tasking subsystem 315, may monitor interactions between data objects associated with healthcare financial subsystem 310 as well as objects more generally associated with system 300. For example, and referring to FIG. 4, a tasking subsystem 415 may manage interactions between one or more source objects 420 and one or more target objects 430. A given source object 420 may have an impact on any one or more target objects 430. Thus, tasking subsystem 415 may manage a plurality of relationships 432 between various source objects 420 and target objects 430. When a new source object 420 is presented, tasking subsystem 415 may generate a new relationship 432 to one or more specific target object 430. Tasking subsystem 415 may utilize one or more rules in a rules database for identifying and managing relationships 432 between source objects 420 and target objects 430. In one example, tasking subsystem 415 determines that an event associated with a source object 420 may have an impact on one or more claim target objects 430 and develops a relationship 432 between the event and/or source object 420 and the target object 430. Tasking subsystem 415 may store relationships 432 in a database (e.g., database 425 or another database). Utilizing rules database 425, tasking subsystem 415 may generate a task object (not shown) including executable instructions for accessing a particular claim target object for submitting the claim target object for processing (e.g., to an adjudication engine, such as adjudication engine 335 of FIG. 3).

FIG. 5 illustrates one embodiment of a task object 500 including an indication of a source object 505 and an indication of a target object 510. In one example, indication of a target object 510 may include an identifying information of one or more claim objects (e.g., claim object 330 of FIG. 3) that may be impacted by an event (e.g., event 320) associated with a source object, such as an object representing a service provider. Task object 500 may also include one or more executable instructions 515 for automatedly accessing one or more claim objects for submission to a claims adjudication engine. One example of claims generation is described with particular reference to FIGS. 9, 10, 11, 12, 15, and 16 of U.S. patent application Ser. No. 10/632,328, filed on Aug. 1, 2003, entitled “Enterprise Task Manager,” which is incorporated herein by reference in its entirety.

Referring again to FIG. 3, system 300 may reside on one or more machines 355. System 300 may also include an access terminal 360 for accessing one or more components of system 300. Access terminal 360 may be connected to system 300 via a network 365 or directly connected to one or more machines 355. In an alternative example, in addition to utilizing task object 327 for automatedly accessing claim 330, tasking subsystem 315 may add task object 327 to a worklist of a worker who may access the worklist via an access terminal, such as access terminal 360.

As discussed above, an exemplary claim may be processed to determine a status of the claim (e.g., whether the claim should be paid in full, paid in part, rejected, or held/pended for lack of information). In some instances it may be necessary to notify a worker of a status of a claim. For example, if a claim is pended, it may be necessary to notify a worker that a piece of information required for processing is missing from a claim. A tasking subsystem, such as tasking subsystem 315 may be utilized to generate a task object that may be added to a worker's worklist. The task object may indicate the source object (e.g., the pended claim) and indicate that a piece of information was missing from the claim.

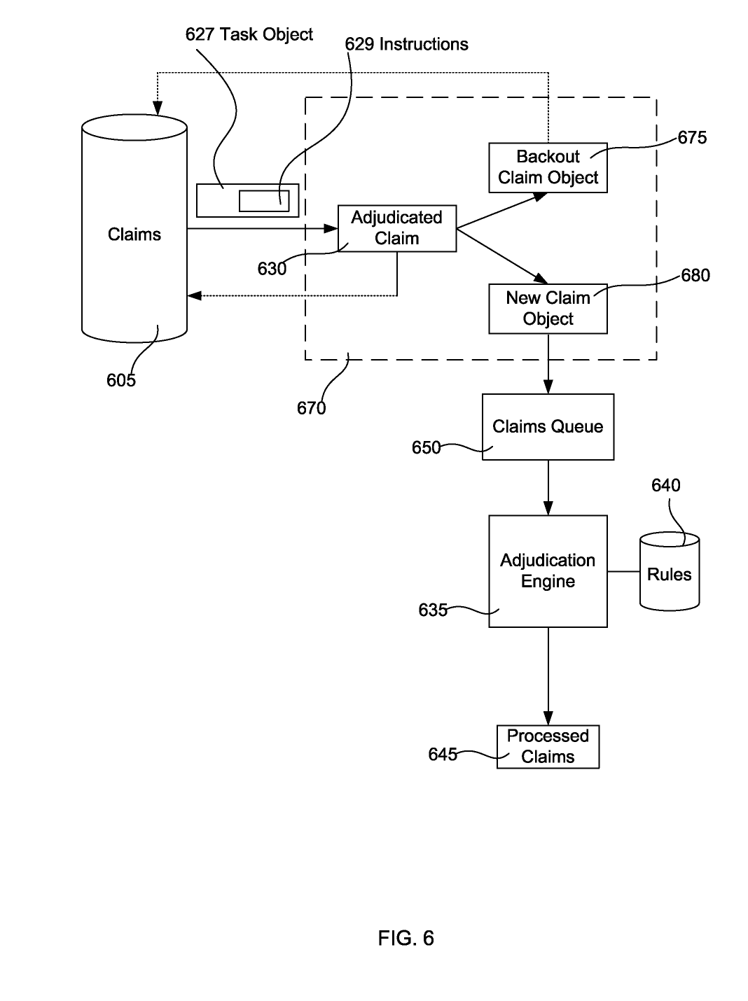

A claim that has been previously processed may already reside in a claims database, such as claims database 305, with a status, for example, of accepted, rejected, or pended. A claim with a status of accepted or rejected may be considered an adjudicated claim. To reprocess an adjudicated claim (e.g., in response to an event), it may be necessary to back out the financial impact of the previously adjudicated claim from the system. FIG. 6 illustrates one embodiment of a system 600 for processing a previously adjudicated claim. System 600 includes components similar to those of system 200 of FIG. 2 and system 300 of FIG. 3. Such components are configured and operate in substantially the same manner as described above with any differences described below with respect to components of system 600. System 600 includes a claims database 605 including one or more claims. A task object 627 includes instructions 629 for automatedly accessing an identified adjudicated claim 630 for submission to an adjudication engine 635. Task object 627 may be generated as discussed above with respect to task object 327 of FIG. 3. Adjudication engine 635 may utilize one or more rules of adjudication rules database 640 in processing one or more claims to one or more processed claims 645. System 600 may optionally include a claims queue 650 for queuing claims prior to submission to adjudication engine 635.

System 600 includes a claims preprocessing module 670 for automatedly preprocessing certain claims that have been previously adjudicated, such as exemplary claim 630. Claims preprocessing module 670 analyzes previously adjudicated claim 630 and generates a backout claim object 675 that includes information for backing out the financial ramifications of the originally adjudicated claim 630. In one example, backout claim object 675 may include information that corresponds to that of originally adjudicated claim 630 that was approved. In such an example, the originally approved claim 630 may include a financial debit corresponding to a payment made to cover one or more charges associated with the one or more services represented by claim 630. A corresponding backout claim 675 to the approved claim 630 may include a financial credit equal to the financial debit of the originally approved claim 630 to offset the financial impact in the system.

Claims preprocessing module 670 may store backout claim object 675 in claims database 605. Since backout claim object 675 does not require processing to determine its status, claims preprocessing module 670 may also include in backout claim object 675 a status indication that will prevent backout claim object 675 from being submitted to adjudication engine 635 for processing. In one example, this may include a status indication, such as “backout.” In another example, this indication may include a flag indicating to system 600 that claim 675 is not to be processed.

Claims preprocessing module 670 also generates a new claim object 680. New claim object 680 may include information from adjudicated claim 630 representing the original claim made for payment and/or new information corresponding to the event that instigated the generation of task object 627. New claim object 680 may then be submitted to adjudication engine 635 for processing as described above.

In an alternative embodiment, the functionality of claims preprocessing module, such as claims preprocessing module 670, may be included in executable instructions, such as instructions 329 of FIG. 3, of a task object, such as task object 327 of FIG. 3.

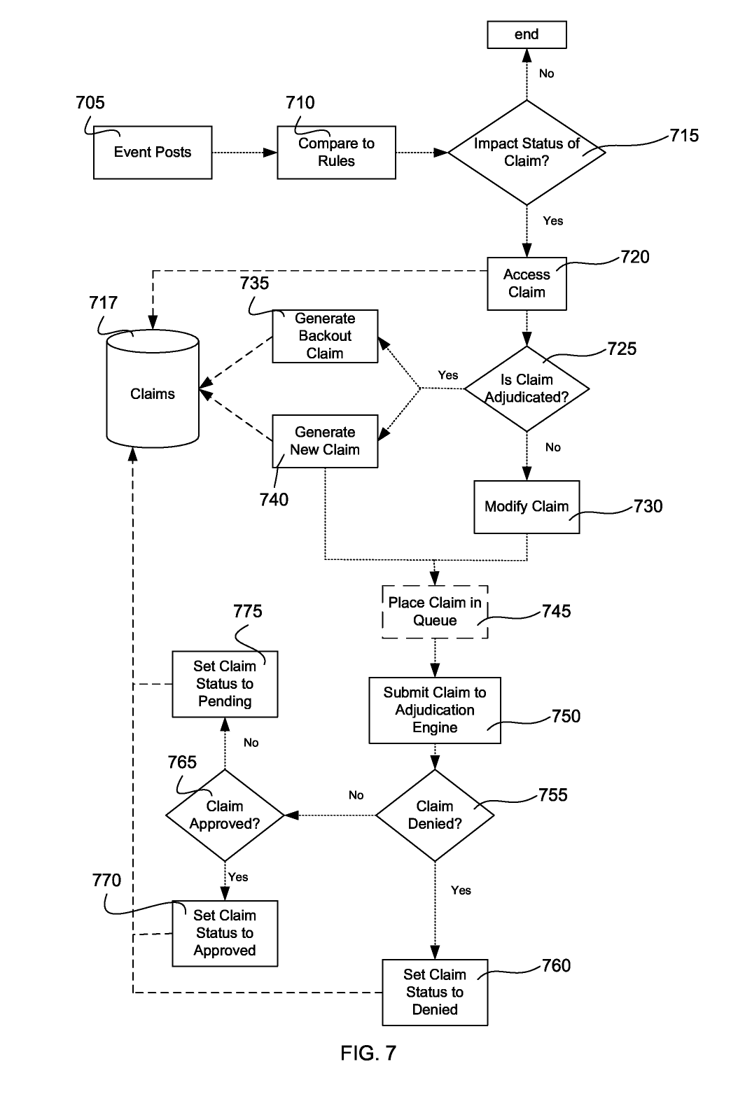

FIG. 7 illustrates one embodiment of a method 700 of automatedly processing a claim. At step 705 an event (e.g., event 220 of FIG. 2, 320 of FIG. 3) occurs. At step 710 the event is automatedly compared to one or more rules (e.g., rules databases 225, 325) to determine at decision step 715 if the event may potentially impact a claim in claims database 717. If the event does not have a potential impact on a claim, the process ends. If the event may have an impact on a claim (e.g., potentially changing the status of the claim), the claim is automatedly accessed at step 720 (e.g., by a task object, such as task object 327). At step 725, the claim is automatedly analyzed (e.g., by a preprocessing module, such as preprocessing module 670 of FIG. 6) to determine if it has been previously adjudicated. If the claim was not previously adjudicated the process proceeds to step 730. If the claim was previously adjudicated, a backout claim is automatedly generated at step 735 and a new claim is automatedly generated at step 740. The backout claim and/or new claim may be stored in claims database 717. In one example, the new claim may include information corresponding to information in the original claim and/or information related to the event that occurred in step 705.

At step 730, a previously non-adjudicated claim may be modified according to information corresponding to the event that occurred in step 705 as necessary. The event may have impacted other information that is not directly part of the claim. In such a situation no modification may be required to the claim at step 730.

At an optional step 745, a new claim generated at step 740 and/or a previously non-adjudicated claim from step 725 may be queued prior to submission to processing.

At step 750, a new claim generated at step 740 and/or a previously non-adjudicated claim from step 725 may be submitted to an adjudication engine (e.g., adjudication engines 235, 335) for processing. At step 755, the claim is analyzed to determine if the claim should be denied. If the claim is denied, the claim status of the claim is set to “denied” at step 760. The claim status may be set in a claim object residing in claim database 717.

If the claim is not to be denied, the process continues to step 765 at which point it is analyzed to determine if it should be approved. If the claim is to be approved a status is set to “approved” at step 770. The claim status may be set in a claim residing in claim database 717. If the claim is not approved, a claim status is set to “pended” at step 775. The claim status may be set in a claim residing in claim database 717.

Claims may be submitted to an adjudication engine at step 750 and processed through steps 775 in groups that may be queued at step 745.

It is to be noted that the aspects and embodiments described herein may be conveniently implemented using one or more machines (e.g., a general purpose computing device) programmed according to the teachings of the present specification, as will be apparent to those of ordinary skill in the computer art. For example, various components of an automated claims processing system, such as systems 200, 300, may be implemented as machine-executable instructions (i.e., software coding), such as program modules executed by one or more machines. Typically a program module may include routines, programs, objects, components, data structures, etc. that perform specific tasks. Appropriate machine-executable instructions can readily be prepared by skilled programmers based on the teachings of the present disclosure, as will be apparent to those of ordinary skill in the software art.

Such software may be a computer program product that employs a machine-readable medium. A machine-readable medium may be any medium that is capable of storing and/or encoding a sequence of instructions for execution by a machine (e.g., a general purpose computing device) and that causes the machine to perform any one of the methodologies and/or embodiments described herein. Examples of a machine-readable medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as a collection of physically separate media, such as, for example, a collection of compact disks or one or more hard disk drives in combination with a computer memory.

Examples of a general purpose computing device include, but are not limited to, a computer workstation, a terminal computer, a server computer, a handheld device (e.g., tablet computer, a personal digital assistant “PDA”, a mobile telephone, etc.), a web appliance, a network router, a network switch, a network bridge, any machine capable of executing a sequence of instructions that specify an action to be taken by that machine, and any combinations thereof. In one example, a general purpose computing device may include and/or be included in, a kiosk.

FIG. 8 shows a diagrammatic representation of one embodiment of a general purpose computing device in the exemplary form of a computer system 800 within which a set of instructions for causing the device to perform any one or more of the aspects and/or methodologies of the present disclosure may be executed. Computer system 800 includes a processor 805 and a memory 810 that communicate with each other, and with other components, via a bus 815. Bus 815 may include any of several types of bus structures including, but not limited to, a memory bus, a memory controller, a peripheral bus, a local bus, and any combinations thereof, using any of a variety of bus architectures.

Memory 810 may include various components (e.g., machine readable media) including, but not limited to, a random access memory component (e.g, a static RAM “SRAM”, a dynamic RAM “DRAM”, etc.), a read only component, and any combinations thereof. In one example, a basic input/output system 820 (BIOS), including basic routines that help to transfer information between elements within computer system 800, such as during start-up, may be stored in memory 810. Memory 810 may also include (e.g., stored on one or more machine-readable media) instructions (e.g., software) 825 embodying any one or more of the aspects and/or methodologies of the present disclosure. In another example, memory 810 may further include any number of program modules including, but not limited to, an operating system, one or more application programs, other program modules, program data, and any combinations thereof.

Computer system 800 may also include a storage device 830. Examples of a storage device (e.g, storage device 830) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 830 may be connected to bus 815 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 830 may be removably interfaced with computer system 800 (e.g., via an external port connector (not shown)). Particularly, storage device 830 and an associated machine-readable medium 835 may provide nonvolatile and/or volatile storage of machine-readable instructions, data structures, program modules, and/or other data for computer system 800. In one example, software 825 may reside, completely or partially, within machine-readable medium 835. In another example, software 825 may reside, completely or partially, within processor 805.

Computer system 800 may also include an input device 840. In one example, a user of computer system 800 may enter commands and/or other information into computer system 800 via input device 840. Examples of an input device 840 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 840 may be interfaced to bus 815 via any of a variety of interfaces (not shown) including, but not limited to, a serial interface, a parallel interface, a game port, a USB interface, a FIREWIRE interface, a direct interface to bus 815, and any combinations thereof.

A user may also input commands and/or other information to computer system 800 via storage device 830 (e.g., a removable disk drive, a flash drive, etc.) and/or a network interface device 845. A network interface device, such as network interface device 845 may be utilized for connecting computer system 800 to one or more of a variety of networks, such as network 850, and one or more remote devices 855 connected thereto. Examples of a network interface device include, but are not limited to, a network interface card, a modem, and any combination thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 850, may employ a wired and/or a wireless mode of communication. In general, any network topology may be used. Information (e.g., data, software 825, etc.) may be communicated to and/or from computer system 800 via network interface device 845.

Computer system 800 may further include a video display adapter 860 for communicating a displayable image to a display device, such as display device 865. Examples of a display device include, but are not limited to, a liquid crystal display (LCD), a cathode ray tube (CRT), a plasma display, and any combinations thereof. In addition to a display device, a computer system 800 may include one or more other peripheral output devices including, but not limited to, an audio speaker, a printer, and any combinations thereof. Such peripheral output devices may be connected to bus 815 via a peripheral interface 870. Examples of a peripheral interface include, but are not limited to, a serial port, a USB connection, a FIREWIRE connection, a parallel connection, and any combinations thereof.

A digitizer (not shown) and an accompanying pen/stylus, if needed, may be included in order to digitally capture freehand input. A pen digitizer may be separately configured or coextensive with a display area of display device 865. Accordingly, a digitizer may be integrated with display device 865, or may exist as a separate device overlaying or otherwise appended to display device 865.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A computerized method of processing a financial claim, the method comprising:
automatedly identifying an event on a financial system, said event potentially impacting a status of one or more financial claims residing in a first database of said financial system;
automatedly accessing said one or more financial claims;
processing said one or more financial claims to generate a processed financial claim for each of said one or more financial claims, said processing based at least in part on information obtained from the event.

2. A computerized method according to claim 1, wherein said financial claim is a healthcare claim.

3. A computerized method according to claim 1, wherein said automatedly identifying step includes:
monitoring the financial system for one or more events; and
comparing the one or more events to a set of rules to determine if any one of the one or more events may have an impact on a status of the one or more financial claims.

4. A computerized method according to claim 3, wherein said monitoring step is performed by a task generation system.

5. A computerized method according to claim 1, further comprising automatedly generating a first task object upon identifying said event, said first task object including an instruction for automatedly accessing said one or more financial claims potentially impacted by said event.

6. A computerized method according to claim 5, further comprising delivering said first task object to a work list of a worker.

7. A computerized method according to claim 6, further comprising said worker manually interrupting said automatedly accessing step.

8. A computerized method according to claim 1, further comprising queuing said one or more financial claims until a first pre-programmed time prior to processing step.

9. A computerized method according to claim 1, wherein said processed financial claim is an adjudicated financial claim.

10. A computerized method according to claim 1, wherein said processed financial claim is a pended financial claim.

11. A computerized method according to claim 10, further comprising automatedly generating a second task object including a first data indicating the pended status of said processed financial claim.

12. A computerized method according to claim 1, further comprising automatedly delivering a notice of said processed financial claim.

13. A computerized method according to claim 1, wherein said one or more financial claims includes a first previously adjudicated financial claim representing one or more services provided and a charge for said one or more services.

14. A computerized method according to claim 13, wherein said processing of said one or more financial claims includes:
automatically generating a backout claim for balancing out said previously adjudicated financial claim in said financial system; and
automatically generating a new claim representing said one or more services provided and including said charge.

15. A system for processing a financial claim, the system comprising:
a database including one or more financial claims;
an event monitor for automatically identifying an event on a financial system, said event impacting a status of said one or more financial claims;
a financial claim access module in communication with said database and said event monitor, said financial claim access module for automatedly accessing said one or more financial claims impacted by said event; and
a financial claim processing engine, in communication with said database and said financial claim access module, for processing said one or more claims impacted by said event to produce an adjudicated claim.

16. A system according to claim 15, wherein said financial claim is a healthcare claim.

17. A system according to claim 15, wherein said financial claim access module includes a task object generation module for generating a task object including a first instruction for automatedly accessing said one or more financial claims impacted by said event.

18. A system according to claim 15, further comprising an event monitoring rules table in communication with said event monitor, said event monitoring rules table including one or more rules for determining if an event impacts a financial claim.

19. A system according to claim 15, further comprising a notification module in communication with said financial claim processing module, said notification module generating a notice indicating an adjudicated status of said adjudicated claim.

20. A system for processing a financial claim, the system comprising:
a means for storing one or more financial claims;
a means for automatically identifying an event on a financial system, said event impacting a status of said one or more financial claims;
a means for automatedly accessing said one or more financial claims impacted by said event; and
a means for processing said one or more claims impacted by said event to produce an adjudicated claim.

21. A system according to claim 20, wherein said financial claim is a healthcare claim.

22. A system according to claim 20, wherein said means for automatically identifying an event on a financial system comprises a means for generating a task object including a first instruction for automatedly accessing said one or more financial claims impacted by said event.

23. A system according to claim 20, further comprising a means for notifying an entity of an adjudicated status of said adjudicated claim.

24. A system according to claim 20, wherein said one or more financial claims includes a first previously adjudicated financial claim representing one or more services provided and a charge for said one or more services.

25. A system according to claim 24, further comprising:
a means for automatically generating a backout claim for balancing out said previously adjudicated financial claim in said financial system; and
a means for automatically generating a new claim representing said one or more services provided and including said charge, said means for automatically generating a new claim delivering said new claim to said means for processing said one or more claims.

26. A computer readable medium containing computer executable instructions implementing a method of processing a financial claim, the instructions comprising:
a set of instructions for automatedly identifying an event on a healthcare financial system, said event impacting a status of one or more financial claims residing in a first database of said financial system;
a set of instruction for automatedly accessing said one or more financial claims;
a set of instructions for processing said one or more financial claims to generate a processed financial claim for each of said one or more financial claims.

27. A computer readable medium according to claim 26, wherein said financial claim is a healthcare claim.

28. A computer readable medium according to claim 26, further comprising a set of instructions for generating a first task object upon identifying said event, said first task object including an instruction for automatedly identifying said one or more financial claims impacted by said event.

29. A computer readable medium according to claim 28, further comprising a set of instructions for delivering said first task object to a work list of a worker.

30. A computer readable medium according to claim 26, further comprising a set of instructions for queuing said one or more financial claims until a first predetermined time prior to processing.

31. A computer readable medium according to claim 26, further comprising a set of instructions for generating a notice of an adjudication status of said processed financial claim.

32. A computer readable medium according to claim 26, wherein said one or more financial claims includes a first previously adjudicated financial claim representing one or more services provided and a charge for said one or more services.

33. A computer readable medium according to claim 32, wherein said set of instruction for processing said one or more financial claims includes:
a set of instructions for automatically generating a backout claim for balancing out said previously adjudicated financial claim in said financial system; and
a set of instruction for automatically generating a new claim representing said one or more services provided and including said charge.
